(19) United States
(12) Patent Application Publication
(10) Pub. No.: US 2010/0076937 A1
(43) Pub. Date: Mar. 25, 2010

(54) FEED PROCESSING

(75) Inventors: Alejandro ABDELNUR, Bangalore (IN); Amit JAISWAL, Delhi (IN); Anis AHMED S.K., Bangalore (IN); Ruchirbhai Rajendra SHAH, Anand (IN); Saurabh SINGLA, Manimazra (IN); Shanmugam SENTHIL, Bangalore (IN)

Correspondence Address: Evergreen Valley Law Group, P.C. and Yahoo! Inc., 4 South Second Street, Suite 598, San Jose, CA, 95113, US

(73) Assignee: Yahoo! Inc., Sunnyvale, CA (US)

(21) Appl. No.: 12/204,805

(22) Filed: Sep. 5, 2008

(51) Int. Cl. G06F 17/30

(52) U.S. Cl. 707/679; 707/E17.044

(57) ABSTRACT

Feed Processing. An example method of processing a feed stored in a storage device includes receiving an input feed. Each record of the feed is associated with one or more unique identifiers. A first unique identifier for each record of the input feed is then generated. Each record of the input feed and each record of the feed is grouped as changed or not changed based on the first unique identifier for each record of the input feed and a first unique identifier for each record of the feed. A second unique identifier for each record of the input feed grouped as changed is also generated. Each record of the input feed grouped as changed and each record of the feed grouped as changed are then regrouped based on the second unique identifier for each record of the input feed and a second unique identifier for each record of the feed. Further, the feed is updated based on the regrouping, whereby a user accessing a record from the storage device obtains updated version of the record.

### BACKGROUND

With the advent of the Internet, the amount of data content that is readily available and accessible to End Users has increased tremendously. Typically, data records are generated by Record Providers that include a person or an application, for examples, news sources, sports sources, weather sources, blogs, libraries, friends, universities, and businesses. These data records are frequently updated and provided to End users in the form of a feed. Thus a feed is a data format used for providing End Users with frequently updated data records. This feed is processed by a Server before the records included in the feed become available to End Users. However, processing the feed is challenging due to presence of hundreds to millions of records in the feed. Further, processing of entire feed is time consuming because typically a new feed submitted by the record provider is minimally different from an earlier feed submitted by the same record provider. In such a case, precious resources are wasted in processing the entire feed when in reality the new feed is only slightly different from the earlier feed. Further processing of an entire feed every time becomes more cumbersome in instances where the feed is submitted by the record providers frequently because of the frequent change in data.

In light of the foregoing discussion, there is a need for an efficient technique for feed processing.

### SUMMARY

Embodiments of the invention described herein provide a method, system and machine-readable medium for feed processing.

An example method for processing a feed stored in a storage device includes receiving an input feed. Each record of the feed is associated with one or more unique identifiers. A first unique identifier for each record of the input feed is then generated. Each record of the input feed and each record of the feed is grouped as changed or not changed based on the first unique identifier for each record of the input feed and a first unique identifier for each record of the feed. A second unique identifier for each record of the input feed grouped as changed is also generated. Each record of the input feed grouped as changed and each record of the feed grouped as changed are then regrouped based on the second unique identifier for each record of the input feed and a second unique identifier for each record of the feed. Further, the feed is updated based on the regrouping, whereby a user accessing a record from the storage device obtains updated version of the record.

An example method for modifying a feed stored in a storage device includes receiving an inventory feed file and an incremental feed file. Each record of the feed is associated with a unique identifier. The inventory feed file includes a unique identifier for each record of the inventory feed file. A unique identifier is then generated for each record of the incremental feed file. Further, an operation corresponding to each record of the incremental feed file and an operation corresponding to each record of the feed are identified based on the unique identifier for each record of the incremental feed file, the unique identifier for each record of the inventory feed file, and the unique identifier for each record of the feed. The operation corresponding to each record of the incremental feed file and the operation corresponding to each record of the feed are then performed thereby updating the feed stored in the storage device.

Another example method for processing a feed stored in a storage device includes receiving an input feed. Each record of the feed is associated with one or more unique identifiers. A unique identifier for each record of the input feed is then generated. Each record of the input feed and each record of the feed is grouped based on the unique identifier for each record of the input feed and a unique identifier for each record of the feed. Each record of a particular group resulting from the grouping is then processed. Further, the feed is updated based on the grouping and the processing, whereby a user accessing a record from the storage device obtains updated version of the record.

An example system for processing a feed stored in a storage device includes a server storage unit for storing instructions. Each record of the feed is associated with one or more unique identifiers. The system also includes a communication interface for receiving an input feed. Further, the system includes a processor for executing instructions. The instructions include generating a first unique identifier for each record of the input feed. Each record of the input feed and each record of the feed is grouped as changed or not changed based on the first unique identifier for each record of the input feed and a first unique identifier for each record of the feed. A second unique identifier for each record of the input feed grouped as changed is also generated. Each record of the input feed grouped as changed and each record of the feed grouped as changed are then regrouped based on the second unique identifier for each record of the input feed and a second unique identifier for each record of the feed. Further, the feed is updated based on the regrouping, whereby a user accessing a record from the storage device obtains updated version of the record.

An example machine-readable medium for processing a feed stored in a storage device includes instructions operable to cause a programmable processor to receive an input feed. Each record of the feed is associated with one or more unique identifiers. A first unique identifier for each record of the input feed is then generated. Each record of the input feed and each record of the feed is grouped as changed or not changed based on the first unique identifier for each record of the input feed and a first unique identifier for each record of the feed. A second unique identifier for each record of the input feed grouped as changed is also generated. Each record of the input feed grouped as changed and each record of the feed grouped as changed are then regrouped based on the second unique identifier for each record of the input feed and a second unique identifier for each record of the feed. Further, the feed is updated based on the regrouping, whereby a user accessing a record from the storage device obtains updated version of the record.

An example machine-readable medium for modifying a feed stored in a storage device includes instructions operable to cause a programmable processor to receive an inventory feed file and an incremental feed file. Each record of the feed is associated with a unique identifier. The inventory feed file includes a unique identifier for each record of the inventory feed file. A unique identifier is then generated for each record of the incremental feed file. Further, an operation corresponding to each record of the incremental feed file and an operation corresponding to each record of the feed are identified based on the unique identifier for each record of the incremental feed file, the unique identifier for each record of the inventory feed file, and the unique identifier for each record of the feed. The operation corresponding to each record of the incremental feed file and the operation corresponding to each record of the feed are then performed thereby updating the feed stored in the storage device.

### BRIEF DESCRIPTION OF THE FIGURES

FIG. 1 is a block diagram of an environment in accordance with which various embodiments can be implemented;

FIG. 2 is a block diagram of a computer system in accordance with one embodiment;

FIG. 3 is a flowchart illustrating a method for processing Feeds in accordance with one embodiment;

FIG. 4 is an exemplary representation of a Feed stored in a storage device and an Input Feed in accordance with one embodiment;

FIG. 5 is a flowchart illustrating a method for processing Feeds in accordance with another embodiment; and

FIG. 6 is a flowchart illustrating a method for modifying Feeds in accordance with one embodiment.

### DETAILED DESCRIPTION OF THE EMBODIMENTS

In various embodiments, “Record Provider” means a person or an application or a system that generates records. “Feed Source” means a person or an application or a system that receives records from one or more Record Providers and makes the records available in the form of a Feed. “Server” means an application or a system that receives the Feed and processes the Feed. “End User” means a person or a subscriber or an application or a system that obtains or receives the Feed from the Server. A Feed means a data format used for providing the End User with frequently updated records. The Feed includes one or more records. The Feed can be in various formats. Examples of the formats include but are not limited comma separated values (CSV) format, tab separated values (TSV) format, hyper text mark-up language (HTML) format, extensible mark-up language (XML) format, and really simple syndication (RSS) format. Input Feed means an incoming Feed from the Feed Source which is going to be processed. The Input Feed is processed by converting the Input Feed into incremental form.

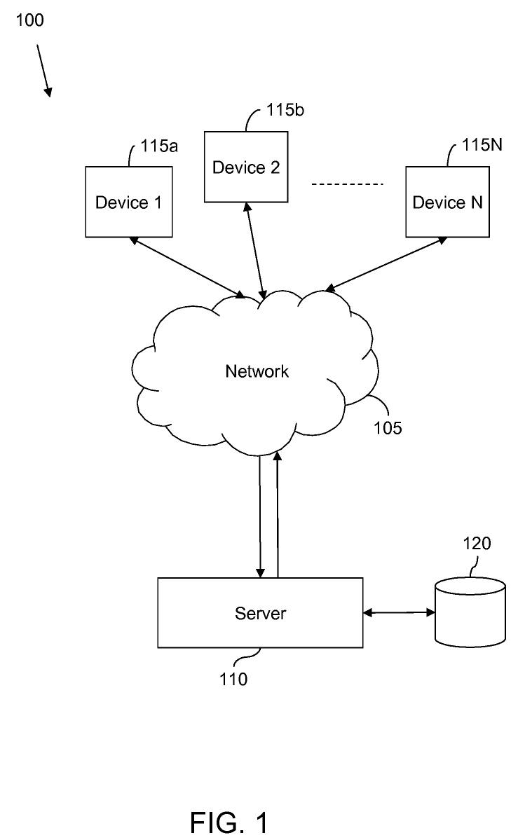

FIG. 1 is a block diagram of an environment 100 in accordance with which various embodiments can be implemented. Environment 100 includes one or more devices, for example, a device 115a, a device 115b and a device 115N connected to each other through network 105. The devices are also connected to a Server 110 through network 105. Server 110 is connected to a storage device 120. Storage device 120 can be a distributed storage system.

Examples of the devices include but are not limited to computers, laptops, mobile devices, data processing units, computing devices, hand held devices, and personal digital assistants (PDAs). Examples of network 105 include but are not limited to a Local Area Network (LAN), a Wireless Local Area Network (WLAN), a Wide Area Network (WAN), internet and a Small Area Network (SAN).

Examples of the Record Provider include but are not limited to news Record Provider, sports Record Provider, weather Record Provider, blogs Record Provider, partners, libraries, friends, universities, and businesses. A given person or an application or a system can be both the Record Provider and the Feed Source.

The Record Provider of a device, for example device 115a sends an Input Feed to Server 110 through network 105. Server 110 updates a Feed stored in storage device 120 using the Input Feed. The updated versions of records are then provided to the End Users. A given person or an application or a system can be both the Record Provider and the End User.

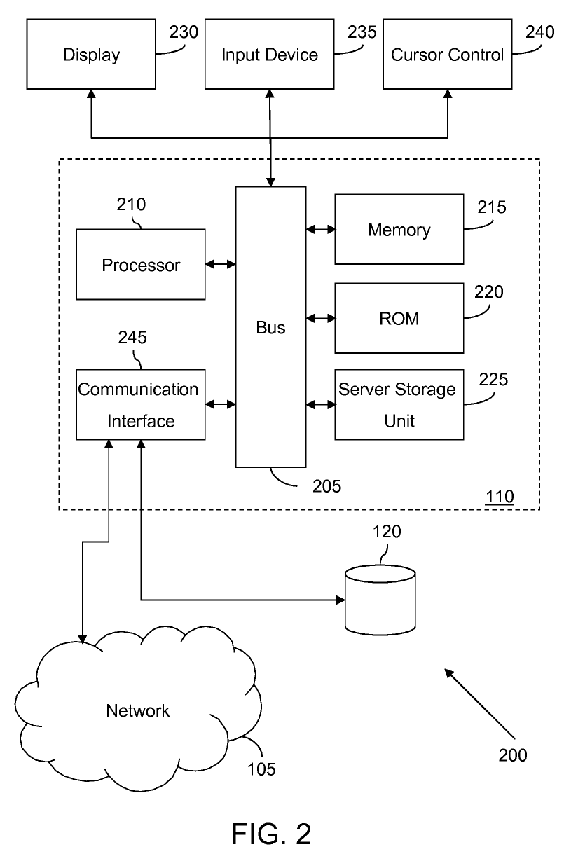

In one embodiment, the records are processed by converting the Input Feed into incremental form and modifying the Feed based on the incremental form of the Input Feed. A system for processing the records by converting the Input Feed into incremental form is explained in detail in conjunction with FIG. 2.

FIG. 2 is a block diagram of a computer system 200 in accordance with one embodiment. Computer system 200 includes a Server 110. Server 110 includes a bus 205 or other communication mechanism for communicating information, and a processor 210 coupled with bus 205 for processing information. Server 110 also includes a memory 215, such as a random access memory (RAM) or other dynamic storage device, coupled to bus 205 for storing information and instructions to be executed by processor 210. Memory 215 can be used for storing temporary variables or other intermediate information during execution of instructions to be executed by processor 210. Server 110 further includes a read only memory (ROM) 220 or other static storage device coupled to bus 205 for storing static information and instructions for processor 210. A server storage unit 225, such as a magnetic disk or optical disk, is provided and coupled to bus 205 for storing information and instructions.

Server 110 can be coupled via bus 205 to a display 230, such as a cathode ray tube (CRT), for displaying information to a computer user. An input device 235, including alphanumeric and other keys, is coupled to bus 205 for communicating information and command selections to processor 210. Another type of user input device is cursor control 240, such as a mouse, a trackball, or cursor direction keys for communicating direction information and command selections to processor 210 and for controlling cursor movement on display 230.

Various embodiments are related to the use of Server 110 for implementing the techniques described herein. In one embodiment, the techniques are performed by Server 110 in response to processor 210 executing instructions included in memory 215. Such instructions can be read into memory 215 from another machine-readable medium, such as server storage unit 225. Execution of the instructions included in memory 215 causes processor 210 to perform the process steps described herein. In alternative embodiments, hard-wired circuitry can be used in place of or in combination with software instructions to implement various embodiments.

The term “machine-readable medium” as used herein refers to any medium that participates in providing data that causes a machine to operate in a specific fashion. In an embodiment implemented using Server 110, various machine-readable medium are involved, for example, in providing instructions to processor 210 for execution. The machine-readable medium can be a storage media. Storage media includes both non-volatile media and volatile media. Non-volatile media includes, for example, optical or magnetic disks, such as server storage unit 225. Volatile media includes dynamic memory, such as memory 215. All such media must be tangible to enable the instructions carried by the media to be detected by a physical mechanism that reads the instructions into a machine.

Common forms of machine-readable medium include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge.

In another embodiment, the machine-readable medium can be a transmission media including coaxial cables, copper wire and fiber optics, including the wires that comprise bus 205. Transmission media can also take the form of acoustic or light waves, such as those generated during radio-wave and infra-red data communications. Examples of machine-readable medium may include but are not limited to a carrier wave as describer hereinafter or any other medium from which a computer can read, for example online software, download links, installation links, and online links. For example, the instructions can initially be carried on a magnetic disk of a remote computer. The remote computer can load the instructions into its dynamic memory and send the instructions over a telephone line using a modem. A modem local to Server 110 can receive the data on the telephone line and use an infra-red transmitter to convert the data to an infra-red signal. An infra-red detector can receive the data carried in the infra-red signal and appropriate circuitry can place the data on bus 205. Bus 205 carries the data to memory 215, from which processor 210 retrieves and executes the instructions. The instructions received by memory 215 can optionally be stored on server storage unit 225 either before or after execution by processor 210. All such media must be tangible to enable the instructions carried by the media to be detected by a physical mechanism that reads the instructions into a machine.

Server 110 also includes a communication interface 245 coupled to bus 205. Communication interface 245 provides a two-way data communication coupling to a network 105. For example, communication interface 245 can be an integrated services digital network (ISDN) card or a modem to provide a data communication connection to a corresponding type of telephone line. As another example, communication interface 245 can be a local area network (LAN) card to provide a data communication connection to a compatible LAN. Wireless links can also be implemented. In any such implementation, communication interface 245 sends and receives electrical, electromagnetic or optical signals that carry digital data streams representing various types of information. The Input Feed can be received by Server 110 through communication interface 245.

Server 110 can send messages and receive data, including program code, through network 105 and communication interface 245. Server 110 can also fetch data from a storage device 120.

The code can be executed by processor 210 as the code is received, or stored in server storage unit 225, or other non-volatile storage for later execution.

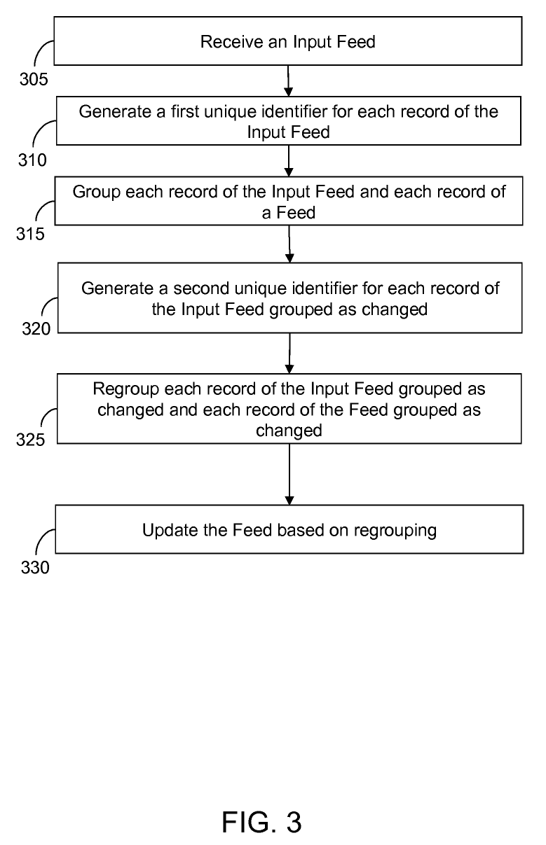

FIG. 3 is a flowchart illustrating a method for processing Feeds in accordance with one embodiment.

A Feed is stored in a storage device. The Feed includes one or more records and one or more unique identifiers for each record. The metadata, for example content-type, associated with the Feed can also be stored in the storage device.

At step 305, an Input Feed is received. The Input Feed includes records provided by Record Providers. A record can be a set of data fields. Each field can be characterized by an attribute and can be occupied by data having a value. For example, in a real estate feed data fields can be characterized by price and address attributes. “INR 1200000” and “#9, MG Road, Bangalore” can be the data present in price and address attributes respectively.

At step 310, a first unique identifier is generated for each record of the Input Feed. The first unique identifier is a string which is unique for each record. The first unique identifier can be generated based on at least one of a record string, a substring of the record string, hash of the record string, and hash of the substring of the record string. For example, for the record “KA04-5959, KAR, Maruti, 800, White, Karnataka, 1200” the first unique identifier can be:
a) a record string or a complete string of the record, for example, first unique identifier=[KA04-5959, KAR, Maruti, 800, White, Karnataka, 1200]
b) a substring of the record string, for example, first unique identifier=[KA04-5959, KAR]
c) a substring of the record string matching a regular expression=“\w+” for example, first unique identifier=[KA04-5959]
d) a substring of the record string based on selected fields, for example, first unique identifier=[KA04-5959KAR1200]
e) a hash of the record string, for example, first unique identifier=[369ff8a795d0026df36d1aac98e3c22c]:
f) a hash of the substring of the record string, for example, first unique identifier=[2dd0149b73aef07a4ad7f5fa2d3207ef]

Various hash algorithms can be used for generating the first unique identifier. Examples of the hash algorithms include but are not limited to a message-digest algorithm (MD5), modulo operator, SHA1, Java hash Code, SHA256, SHA512 or any other hash algorithm.

In one embodiment, portions from the record not required for the purpose of generation of the first unique identifier can be filtered out. For example, time stamps or time at which the record was generated can be excluded. The Record Provider adds the time at which the record was generated and sends the record. The added time can be excluded for the purpose of generation of the first unique identifier, because actual contents of the record have not changed. In another example, the address attribute can include “#9, MG Road” as one address and “No. 9, MG Road” as other address. The “#” and “No.” can then be filtered out in order to generate similar first unique identifier for records having dissimilarity only in “#” and “No.”.

In cases when there is no Feed stored in the storage device and the Input Feed is received then no first unique identifier needs to be generated for the Input Feed and the Input Feed is inserted in the storage device.

At step 315, each record of the Input Feed and each record of the Feed stored in the storage device are grouped into one or more groups based on the first unique identifier for each record of the Input Feed and the first unique identifier for each record of the Feed. The first unique identifier for each record of the Feed can be retrieved from the storage device. In one embodiment, in case the first unique identifiers for the Feed are not stored in the storage device then the first unique identifiers for the Feed can be generated. The groups include a CHANGE group and a NO CHANGE group. The CHANGE group further includes an INTERMEDIATE INSERT group, and a INTERMEDIATE DELETE group. The CHANGE group includes records that have changed from the Feed to the Input Feed. The NO CHANGE group includes records common to the Feed and the Input Feed. In other aspect, the CHANGE group includes records for which the first unique identifiers are different in the Feed and the Input Feed and the NO CHANGE group includes records that have similar first unique identifiers in the Feed and the Input Feed. The INTERMEDIATE INSERT group includes records corresponding to the first unique identifiers which are absent in the Feed but are present in the Input Feed. The INTERMEDIATE DELETE group includes records corresponding to the first unique identifiers which are present in the Feed but are absent in the Input Feed.

The groups can also include a DUPLICATE group of the Input Feed and a DUPLICATE group of the Feed. The DUPLICATE group includes the duplicates of the records. The DUPLICATE group of the Input Feed includes records which are similar in the Input Feed and as such have similar first unique identifier in the Input Feed. The DUPLICATE group of the Feed includes records which are similar in the Feed and as such have similar first unique identifier in the Input Feed.

The grouping is performed based on counting of the records in the Input Feed and the Feed. For example, two records having similar first unique identifier can be present in the Input Feed and can be absent in the Feed. One record can then be grouped into the INTERMEDIATE INSERT group and the other record can be grouped into the DUPLICATE group of the Input Feed. The records of the DUPLICATE group can then be dropped or processed.

Thereafter at step 320, a second unique identifier is generated for each record of the Input Feed grouped as changed. The second unique identifier can be generated based on at least one of a record string, a substring of the record string, hash of the record string, and hash of the substring of the record string. The second unique identifier is generated based on logic of the Input Feed or type of the Input Feed which indicates attributes that are specific or unique to the records of the Input Feed. For example, in the Input Feed related to vehicles the registration numbers can be used as specific attributes for generating the second unique identifiers as each vehicle can be uniquely identified using the registration numbers. The registration numbers can form the unique identity for the vehicle Feed. In another example, attributes of a real estate Input Feed can include address, number of bedrooms, number of bathrooms, and price. The attributes address and number of bedrooms can act as unique attributes for records of the real estate Input Feed. The second unique identifiers can then be generated using any method or hash algorithms as used for generating the first unique identifier. For example, the values of the specific attributes of a record can be concatenated and then MD5 can be applied to generate the second unique identifier for the record. The unique attributes for the Input Feed can be predefined for a type of Input Feed or can be defined by the Record Provider or any other entity.

It will be appreciated that the second unique identifiers can be generated based on any logic which helps in identifying the attributes which are unique or specific for the data of the Input Feed.

In one embodiment, in case the second unique identifiers for the Feed are not stored in the storage device then the second unique identifiers for the Feed can be generated.

At step 325, each record of the Input Feed grouped as changed and each record of the Feed grouped as changed are regrouped based on the second unique identifier for each record of the input feed and the second unique identifier for each record of the feed.

The CHANGE group is regrouped into one or more groups based on the second unique identifiers. The groups include an INSERT group, a DELETE group and an UPDATE group. The regrouping is performed based on counting of the records in the Input Feed and the Feed. The UPDATE group includes records in the Input Feed corresponding to the second unique identifier present in both the Feed and the Input Feed, but having different first unique identifiers in the Feed and the Input Feed. In other aspect, the UPDATE group includes records of the Feed in which a data field differs from a corresponding data field in an associated record in the Input Feed. The associated record is the record having a similar second unique identifier in the Feed and the Input Feed. The records which have same specific attributes but differ in other attributes may have same second unique identifier.

The INSERT group includes records in the Input Feed corresponding to the second unique identifiers which are absent in the Feed but are present in the Input Feed, and have different first unique identifiers in the Feed and the Input Feed. In other aspect, the INSERT group includes records that are absent in the storage device but are present in the Input Feed.

The DELETE group includes records corresponding to the second unique identifiers which are absent in the Input Feed but are present in the Feed, and have different first unique identifiers in the Feed and the Input Feed. In other aspect, the DELETE group includes records that are present in the storage device but are absent in the Input Feed.

A processor performing the regrouping has the knowledge of the first unique identifiers, grouping based on the first unique identifiers and the second unique identifiers, and hence, performs the regrouping based on the knowledge

At step 330, the Feed is updated based on the regrouping. The updating includes at least one of deleting a record present in the feed but absent in the input feed, inserting a record absent in the feed but present in the input feed, and altering a record present in both the feed and the input feed.

The groups after regrouping include at least one of the INSERT group, the DELETE group and the UPDATE group. The updating may then include at least one of inserting the INSERT group in the Feed, deleting the DELETE group from the Feed and updating the Feed with the UPDATE group. The first unique identifiers and the second unique identifiers associated with the records of the groups are also added, deleted or altered based on the type of group. For example, for the DELETE group the first unique identifiers and the second unique identifiers are deleted from the storage device, for the INSERT group the first unique identifiers and the second unique identifiers are inserted in the storage device, and for the UPDATE group the second unique identifier remains unchanged while the first unique identifier is altered to the first unique identifier of the records in the Input Feed.

The INSERT group, the UPDATE group, the DELETE group formed after the regrouping and the NO CHANGE group forms the incremental feed.

The records after updating are then stored for future use as the Updated Feed. The Updated Feed then becomes a Feed for subsequent Input Feed. The updating can include storing one or more of the first unique identifiers, the second unique identifiers, the records or metadata associated with the records. The End Users accessing a record gets an updated version of the record.

In one embodiment, the records that have not changed in the Input Feed from the Feed need not be processed any further. For example, if the Record Provider gives an uniform resource locator (URL) of an image in the Input Feed and the URL is present in the record categorized into the NO CHANGE group then the image processing may not be required again as the image had been processed in the Feed. The records of the Input Feed which have changed or which are categorized into the INSERT group and the UPDATE group may be further processed before the contents of the records become available to the End Users. In some embodiments, the further processing of the UPDATE group includes optimizing the processing of different attributes of the records of the UPDATE group by comparing the records of the Feed and the Input Feed to find attributes that have changed. Based on the comparison the processing can then be done. For example, if an attribute is additional in the Input Feed then update can be performed by adding that attribute in the record of the Feed and not processing any other attribute. For unchanged attributes the data can be fetched from the Feed. This helps in saving time and resources.

In one embodiment, steps 305 to step 330 can be performed in a distributed file system. The Feed can be fetched from the storage device. The output of steps 305 to step 330 may be pushed into the storage device at various times. The data can be fetched from the storage device and hence, in case of a crash of the distributed file system the data can be recovered from database of the storage device. The data may include content of the Feed, the first unique identifiers, the second unique identifiers or metadata of the Feed.

It will be appreciated that one or more steps of FIG. 3 may be performed in parallel. It will also be appreciated that the order of steps may be different based on the requirement. For example, step 310 may be performed in parallel to step 320.

The first unique identifiers are generated using a similar algorithm for the Input Feed and the Feed. The second unique identifiers are also generated using a same algorithm for the Input Feed and the Feed.

The method of FIG. 3 can be implemented in a workflow and various other steps, for example, normalization and verification of data in the Input Feed can be performed and added to the workflow.

It will also be appreciated that the method of FIG. 3 is explained with help of Feed processing and one or more steps of the method may be used in various applications where it is desired to convert full data into incremental version by using the unique identifiers and previously processed data. For example, the method can be used in case of a crawler which crawls a website daily and writes to a log file the time at which the crawler fetched a page, the URL that the crawler visited, and the contents of the page corresponding to the URL. Each record in the log file then includes three attributes—timestamp, URL, and page content. Now, the requirement can be to find what pages have been added, deleted or updated each day in the website. The time stamp can be ignored while calculating a first unique identifier and the first unique identifier can be calculated based on the URL and the page content. The URL can be the specific attribute and can be used to generate the second unique identifier. Thereafter, the grouping can be performed.

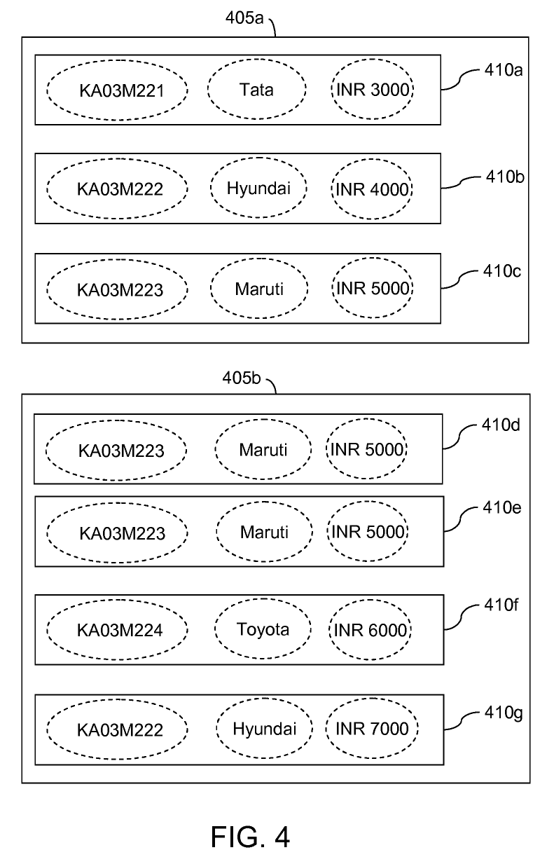

The method described in FIG. 3 is explained with help of an example in conjunction with FIG. 4.

FIG. 4 is an exemplary representation of a Feed 405a and an Input Feed 405b in accordance with one embodiment. Feed 405a includes one or more records, for example a record 410a, a record 410b and a record 410c. Feed 405a is stored in a storage device along with one or more unique identifiers for each record. Input Feed 405b also includes one or more records, for example a record 410d, a record 410e and a record 410f. Each record includes one or more attributes, for example a registration number, brand name and a price.

In illustrated example, the records of Feed 405a and Input Feed 405b are in similar format. In another embodiment, the records of Feed 405a and Input Feed 405b may be in different formats and may require pre-processing to make the formats similar.

In illustrated example, Feed 405a and Input Feed 405b are vehicle related Feeds. Input Feed 405b is received from a Record Provider and processed. First unique identifiers are then generated for the records of Input Feed 405b. First unique identifiers and second unique identifiers of the records of Feed 405a are fetched.

Table 1 illustrates the first unique identifiers of the records of Feed 405a and Input Feed 405b.

TABLE 1

| First unique | |
|---|---|
| identifiers | Record |
| F0 | Record 410a |
| F1 | Record 410b |
| F2 | Record 410c |
| F2 | Record 410d |
| F2 | Record 410e |
| F3 | Record 410f |
| F4 | Record 410g |

In illustrated example, the first unique identifiers for the records are generated based on the contents of the records using an MD5 algorithm and are represented as F0, F1, F2, F3 and F4. The records having similar content have same first unique identifier, for example, F2 for record 410c, record 410d and record 410e.

Thereafter, a plurality of groups is created from Input Feed 405b and Feed 405a based on the first unique identifiers of Input Feed 405b and the first unique identifiers of Feed 405a. The plurality of groups include a CHANGE group and a NO CHANGE group. The CHANGE group includes an INTERMEDIATE INSERT group and an INTERMEDIATE DELETE group.

Table 2 illustrates the plurality of groups.

TABLE 2

| First unique | | Input | |
|---|---|---|---|
| identifiers | Feed 405a | Feed 405b | Group |
| F0 | 1 | 0 | INTERMEDIATE |
| | | | DELETE |
| F1 | 1 | 0 | INTERMEDIATE |
| | | | DELETE |
| F2 | 1 | 2 | NO CHANGE |
| F3 | 0 | 1 | INTERMEDIATE |
| | | | INSERT |
| F4 | 0 | 1 | INTERMEDIATE |
| | | | INSERT |

In illustrated example, the grouping is based on counting of number of records. For example, in Table 2 the value of a cell corresponding to F2 and Feed 405a is “1” as record 410c having F2 as the first unique identifier is present in Feed 405a and the value of a cell corresponding to F2 and Input Feed 405b is “2” as record 410d and record 410e having F2 as the first unique identifier are present in Input Feed 405b. Record 410d and record 410e are then grouped as NO CHANGE group. Further, as record 410d and record 410e have similar first unique identifier any one record out of the two is grouped into a DUPLICATE group of Input Feed 405b. Record 410d is grouped into the NO CHANGE group and record 410e is grouped into the DUPLICATE group of Input Feed 405b. Similarly, grouping is performed for other records. Record 410a and record 410b are grouped into the INTERMEDIATE DELETE group as F0 and F1 are absent in Input Feed 405b, and record 410f and record 410g are grouped into the INTERMEDIATE INSERT group as F3 and F4 are absent in Feed 405a.

In one embodiment, the records of the CHANGE group are processed further. In another embodiment, the records of the NO CHANGE group and the CHANGE group may also be processed further.

In illustrated example, the records of the CHANGE group including the INTERMEDIATE INSERT group and the INTERMEDIATE DELETE group are processed further. Second unique identifiers are generated for Input Feed 405b. The second unique identifiers are generated based on attributes which are specific to the logic of Input Feed 405b or type of Input Feed 405b. The specific attributes can be predefined or can be defined by the Record Providers. In illustrated example, the specific attribute includes the registration number as a vehicle can be uniquely identified from the registration number. The registration number is issued by an authorized party and is unique for each vehicle. The MD5 algorithm is then applied to the registration number attribute and the second unique identifiers are generated.

Table 3 illustrates the second unique identifiers of the records of the INTERMEDIATE INSERT group and the INTERMEDIATE DELETE group.

TABLE 3

| Second unique | |
|---|---|
| identifiers | Record |
| S0 | Record 410a |
| S1 | Record 410b |
| S2 | Record 410f |
| S1 | Record 410g |

S0, S1 and S2 are exemplary representations of the second unique identifiers. Record 410b and record 410g have similar second unique identifier as the specific attribute is similar.

Thereafter, the records of the CHANGE group are classified into an INSERT group, a DELETE group and an UPDATE group based on the second unique identifiers of records of Feed 405a grouped as changed and the second unique identifiers of records of Input Feed 405b grouped as changed.

Table 4 illustrates regrouping of records of the CHANGE group into the INSERT group, the DELETE group and the UPDATE group.

TABLE 4

| Second unique | | Input Feed | |
|---|---|---|---|
| identifiers | Feed 405a | 405b | Group |
| S0 | 1 | 0 | DELETE |
| S1 | 1 | 1 | UPDATE |
| S2 | 0 | 1 | INSERT |

In illustrated example, the regrouping is based on counting of number of records. For example, in Table 4 the value of a cell corresponding to S1 and Feed 405a is “1” as record 410b having S1 as the second unique identifier is present in Feed 405a and the value of a cell corresponding to S1 and Input Feed 405b is “1” as record 410g having S1 as the second unique identifier is present in Input Feed 405b. Record 410g is then regrouped as the UPDATE group. Similarly, grouping is performed for other records. Record 410a is grouped into the DELETE group as S0 is absent in Input Feed 405b, and record 410f is grouped into the INSERT group as S2 is absent in Feed 405a.

Thereafter, Feed 405a is updated based on the regrouping. In illustrated example, the groups formed after regrouping includes the INSERT group, the DELETE group and the UPDATE group. The updating includes inserting record 410f in Feed 405a, deleting record 410a from Feed 405a and altering record 410b of Feed 405a with record 410g by altering INR 4000 with INR 7000. The first unique identifiers and the second unique identifiers associated with the records of the groups are also added, deleted, altered or remains unchanged based on the type of group. The records are then stored for future use. The End Users upon accessing the record obtains an updated version of the record.

In illustrated example, the first unique identifiers and the second unique identifiers of Input Feed 405b and Feed 405a are used to generate incremental Feed including the INSERT group, the DELETE group, the UPDATE group and the NO CHANGE group.

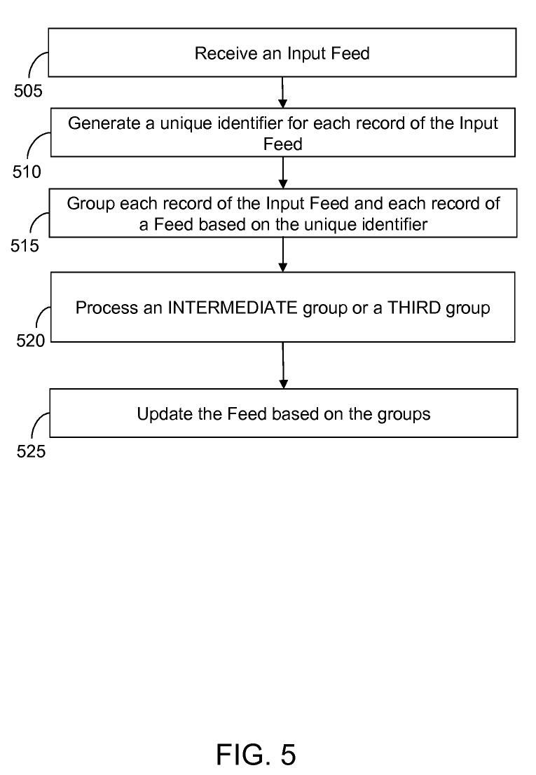

FIG. 5 is a flowchart illustrating a method for processing Feeds in accordance with another embodiment.

A Feed is stored in a storage device. The Feed includes one or more records and one or more unique identifiers for each record. The metadata, for example content-type, associated with the Feed can also be stored in the storage device.

At step 505, an Input Feed is received. The Input Feed includes records provided by Record Providers.

At step 510, a unique identifier is generated for each record of the Input Feed. The unique identifier is a string which is unique for each record. The unique identifier can be generated based on at least one of a record string, a substring of the record string, hash of the record string, and hash of the substring of the record string. The unique identifier can be also based on attributes specific to the logic of the incremental feed file or type of feed included in the incremental feed file.

At step 515, each record of the Input Feed and each record of the Feed stored in the storage device are grouped into one or more groups based on the unique identifier for each record of the Input Feed and the unique identifier for each record of the Feed. The unique identifier for each record of the Feed can be retrieved from the storage device. In one embodiment, in case the unique identifiers for the Feed are not stored in the storage device then the unique identifiers for the Feed can be generated.

If the unique identifier is based on the specific attributes then the groups include an INSERT group, a DELETE group and an INTERMEDIATE group. The INSERT group includes records corresponding to the unique identifiers which are absent in the Feed but are present in the Input Feed. The DELETE group includes records corresponding to the unique identifiers which are present in the Feed but are absent in the Input Feed. The INTERMEDIATE group includes records corresponding to the unique identifiers which are present in both the Feed and the Input Feed.

If the unique identifier is not based on the specific attributes then the groups include a NO CHANGE group, a DELETE group and a THIRD group. The NO CHANGE group includes records corresponding to the unique identifiers present in both the Feed and the Input Feed. The DELETE group includes records corresponding to the unique identifiers present in the Feed but absent in the Input Feed. The THIRD group includes records corresponding to the unique identifiers absent in the Feed but present in the Input Feed.

The groups can also include a DUPLICATE group of the Input Feed and a DUPLICATE group of the Feed. The DUPLICATE group includes the duplicates of the records. The DUPLICATE group of the Input Feed includes records which are similar in the Input Feed and as such have similar unique identifier in the Input Feed. The DUPLICATE group of the Feed includes records which are similar in the Feed and as such have similar unique identifier in the Input Feed.

It will be appreciated that for the Input Feed the unique identifiers will be generated either based on the specific attributes or not based on the specific attributes.

At step 520, if the unique identifiers are based on the specific attributes then the INTERMEDIATE group is processed further. The INTERMEDIATE group is a particular group that needs to be processed. The records of the INTERMEDIATE group are analyzed to check if the content has changed from the Feed to the Input Feed for a record. If some content has changed for the record from the Feed to the Input Feed then the record is grouped into an UPDATE group, else, the record is grouped into a NO CHANGE group. Any other way of grouping the records of the INTERMEDIATE group into the UPDATE group and the NO CHANGE group can also be used.

If the unique identifiers are not based on the specific attributes then the THIRD group and the DELETE group can be processed further. The THIRD group is a particular group that needs to be processed. The further processing can be performed by generating unique identifiers based on the specific attributes. If no specific attributes can be identified then the records of the THIRD group can be grouped as INSERT.

At step 525, the Feed is updated based on the groups formed at step 520. The records of the INSERT group can be inserted in the storage device. The records of the DELETE group can be deleted from the storage device. The records of the UPDATE group can be altered with the content of the Input Feed in the storage device.

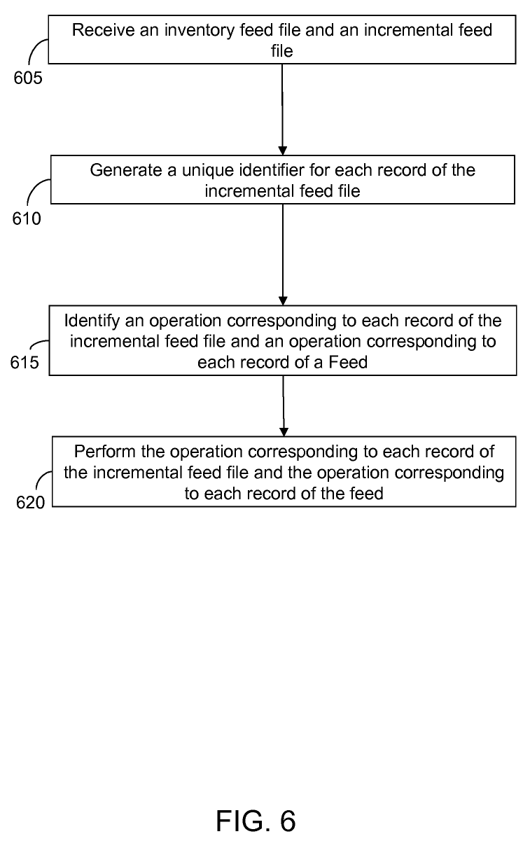

FIG. 6 is a flowchart illustrating a method for modifying Feeds in accordance with one embodiment.

A Feed is stored in a storage device. The Feed includes one or more records and a unique identifier for each record. The metadata, for example content-type, associated with the Feed can also be stored in the storage device.

At step 605, an inventory feed file and an incremental feed file is received. The inventory feed file and the incremental feed file are provided by a Record Provider. The inventory feed file is a master file including all records provided by the Record Provider. In other aspect, the inventory feed file can be defined as the master file including all records which should be present in the Feed stored in the storage device after the Feed is updated by processing the incremental feed file. The inventory feed file is a source of truth and is important in cases where the incremental feed file or the Feed stored in the storage device goes out of sync. The incremental feed file includes the records with which the Feed stored in the storage device is modified. The inventory feed file includes a unique identifier for each record included in the inventory feed file.

At step 610, a unique identifier is generated for each record of the incremental feed file. The unique identifier is a string which is unique for each record. The unique identifier can be generated based on at least one of a record string, a substring of the record string, hash of the record string, and hash of the substring of the record string. The unique can be also based on attributes specific to the logic of the incremental feed file or type of feed included in the incremental feed file.

At step 615, an operation corresponding to each record of the incremental feed file and an operation corresponding to each record of the Feed are identified based on the unique identifier for each record of the incremental feed file, the unique identifier for each record of the inventory feed file, and the unique identifier for each record of the Feed. The operations can include at least one of update, delete and insert. The operations can also include ignoring a record, reporting a missing record or making no change. The operations are identified by applying logic based on presence of the unique identifier in the inventory feed file, the Feed and the incremental feed file.

Table 5 illustrates an exemplary logic for identification of the operations.

TABLE 5

| Inventory | | Incremental | Operation |
|---|---|---|---|
| Feed File | Feed | Feed File | on record |
| Not Present | Present | Not Present | DELETE |
| Not Present | Not Present | Present | IGNORE |
| Not Present | Present | Present | DELETE |
| Present | Not Present | Not Present | Report as |
| Present | Not Present | Present | INSERT |
| Present | Present | Not Present | NO CHANGE |
| Present | Present | Present | UPDATE |

At step 620, the operation corresponding to each record of the incremental feed file and the operation corresponding to each record of the feed are performed. The performing includes at least one of deleting a record absent in the inventory feed file but present in the feed or present in the feed and the incremental feed file, inserting a record present in the inventory feed file and the incremental feed file but absent in the feed, and altering a record present in the inventory feed file, the incremental feed file and the feed. The presence or absence of a record in the incremental feed file, the Feed or the inventory feed file is determined using the unique identifier. The unique identifiers for the incremental feed file are stored in the storage device.

The Feed is modified or updated as a result of the operations performed. An End User accessing the records obtains the updated version of the records.

Various embodiments provide a method for converting the Input Feed into incremental form and processing selective groups from the incremental form. The processing of selected groups improves time efficiency and optimizes resource utilization. The improvement in time efficiency helps in meeting stringent service level requirements.

While exemplary embodiments of the invention have been disclosed, the present disclosure may be practiced in other ways. Various modifications and enhancements may be made without departing from the scope of the present disclosure. The present disclosure is to be limited only by the claims.

What is claimed is:

1. A computer-implemented method for processing a feed stored in a storage device, each record of the feed being associated with one or more identifiers, the computer-implemented method comprising:
receiving an input feed;
generating a first unique identifier for each record of the input feed;
grouping each record of the input feed and each record of the feed as changed or not changed based on the first unique identifier for each record of the input feed and a first unique identifier for each record of the feed;
generating a second unique identifier for each record of the input feed grouped as changed;
regrouping each record of the input feed grouped as changed and each record of the feed grouped as changed based on the second unique identifier for each record of the input feed and a second unique identifier for each record of the feed; and
updating the feed based on the regrouping, whereby a user accessing a record from the storage device obtains updated version of the record.

2. The computer-implemented method of claim 1, wherein the first unique identifier and the second unique identifier for each record are generated based on at least one of:
a record string;
a substring of the record string;
hash of the record string; and
hash of the substring of the record string.

3. The computer-implemented method of claim 2, wherein the second unique identifier is generated further based on one or more attributes, wherein the one or more attributes are specific to the records of the Input Feed.

4. The computer-implemented method of claim 1, wherein the updating comprises at least one of:
deleting a record present in the feed but absent in the input feed;
inserting a record absent in the feed but present in the input feed; and
altering a record present in both the feed and the input feed.

5. The computer-implemented method of claim 1 further comprising:
storing the first unique identifier and the second unique identifier for each record of the input feed in the storage device.

6. A computer-implemented method for modifying a feed stored in a storage device, each record of the feed being associated with a unique identifier, the computer-implemented method comprising:
receiving an inventory feed file and an incremental feed file, wherein the inventory feed file comprises a unique identifier for each record of the inventory feed file;
generating a unique identifier for each record of the incremental feed file;
identifying an operation corresponding to each record of the incremental feed file and an operation corresponding to each record of the feed based on the unique identifier for each record of the incremental feed file, the unique identifier for each record of the inventory feed file, and the unique identifier for each record of the feed; and
performing the operation corresponding to each record of the incremental feed file and the operation corresponding to each record of the feed thereby updating the feed stored in the storage device.

7. The computer-implemented method of claim 6, wherein the unique identifier is generated based on at least one of:
a record string;
a substring of the record string;
hash of the record string; and
hash of the substring of the record string.

8. The computer-implemented method of claim 6, wherein the performing comprises at least one of:
deleting a record absent in the inventory feed file but present in the feed or present in the feed and the incremental feed file;
inserting a record present in the inventory feed file and the incremental feed file but absent in the feed; and
altering a record present in the inventory feed file, the incremental feed file and the feed.

9. The computer-implemented method of claim 6 further comprising:
storing the unique identifier for each record of the incremental feed file in the storage device.

10. A computer-implemented method for processing a feed stored in a storage device, each record of the feed being associated with one or more identifiers, the computer-implemented method comprising:
receiving an input feed;
generating a unique identifier for each record of the input feed;
grouping each record of the input feed and each record of the feed based on the unique identifier for each record of the input feed and a unique identifier for each record of the feed;
processing each record of a particular group resulting from the grouping; and
updating the feed based on the grouping and the processing, whereby a user accessing a record from the storage device obtains updated version of the record.

11. The computer-implemented method of claim 10, wherein the unique identifier is generated based on one or more attributes, wherein the one or more attributes are specific to the records of the Input Feed.

12. A system for processing a feed stored in a storage device, each record of the feed being associated with one or more identifiers, the system comprising:
a communication interface for receiving an input feed;
a system storage unit for storing instructions; and
a processor for executing the instructions, the instructions for:
generating a first unique identifier for each record of the input feed;
grouping each record of the input feed and each record of the feed as changed or not changed based on the first unique identifier for each record of the input feed and a first unique identifier for each record of the feed;
generating a second unique identifier for each record of the input feed grouped as changed;
regrouping each record of the input feed grouped as changed and each record of the feed grouped as changed based on the second unique identifier for each record of the input feed and a second unique identifier for each record of the feed; and
updating the feed based on the regrouping, whereby a user accessing a record from the storage device obtains updated version of the record.

13. The system of claim 12, wherein the first unique identifier and the second unique identifier for each record are generated based on at least one of:
a record string;
a substring of the record string;
hash of the record string; and
hash of the substring of the record string.

14. The system of claim 13, wherein the second unique identifier is generated further based on one or more attributes, wherein the one or more attributes are specific to the records of the Input Feed.

15. The system of claim 12, wherein the updating comprises at least one of:
deleting a record present in the feed but absent in the input feed;
inserting a record absent in the feed but present in the input feed; and
altering a record present in both the feed and the input feed.

16. A machine-readable medium for processing a feed stored in a storage device, each record of the feed being associated with one or more identifiers, the machine-readable medium comprising instructions operable to cause a programmable processor to perform:
receiving an input feed;
generating a first unique identifier for each record of the input feed;
grouping each record of the input feed and each record of the feed as changed or not changed based on the first unique identifier for each record of the input feed and a first unique identifier for each record of the feed;
generating a second unique identifier for each record of the input feed grouped as changed;
regrouping each record of the input feed grouped as changed and each record of the feed grouped as changed based on the second unique identifier for each record of the input feed and a second unique identifier for each record of the feed; and
updating the feed based on the regrouping, whereby a user accessing a record from the storage device obtains updated version of the record.

17. The machine-readable medium of claim 16, wherein the first unique identifier and the second unique identifier for each record are generated based on at least one of:
a record string;
a substring of the record string;
hash of the record string; and
hash of the substring of the record string.

18. The machine-readable medium of claim 17, wherein the second unique identifier is generated further based on one or more attributes, wherein the one or more attributes are specific to the records of the Input Feed.

19. The machine-readable medium of claim 16, wherein the updating comprises at least one of:
deleting a record present in the feed but absent in the input feed;
inserting a record absent in the feed but present in the input feed; and
altering a record present in both the feed and the input feed.

20. The machine-readable medium of claim 16 further comprising instructions operable to cause the programmable processor to perform:
storing the first unique identifier and the second unique identifier for each record of the input feed in the storage device.

21. A machine-readable medium for modifying a feed stored in the storage device, each record of the feed being associated with a unique identifier, the machine-readable medium comprising instructions operable to cause a programmable processor to perform:
receiving an inventory feed file and an incremental feed file, wherein the inventory feed file comprises a unique identifier for each record of the inventory feed file;
generating a unique identifier for each record of the incremental feed file;
identifying an operation corresponding to each record of the incremental feed file and an operation corresponding to each record of the feed based on the unique identifier for each record of the incremental feed file, the unique identifier for each record of the inventory feed file, and the unique identifier for each record of the feed; and
performing the operation corresponding to each record of the incremental feed file and the operation corresponding to each record of the feed thereby updating the feed stored in the storage device.

22. The machine-readable medium of claim 21, wherein the unique identifier is generated based on at least one of:
a record string;
a substring of the record string;
hash of the record string; and
hash of the substring of the record string.

23. The machine-readable medium of claim 21, wherein the performing comprises at least one of:
deleting a record absent in the inventory feed file but present in the feed or present in the feed and the incremental feed file;
inserting a record present in the inventory feed file and the incremental feed file but absent in the feed; and
altering a record present in the inventory feed file, the incremental feed file and the feed.

24. The machine-readable medium of claim 21 further comprising instructions operable to cause the programmable processor to perform:
storing the unique identifier for each record of the incremental feed file in the storage device.
